(19) United States
(12) Patent Application Publication
(10) Pub. No.: US 2011/0185129 A1
(43) Pub. Date: Jul. 28, 2011

(54) SECONDARY JAVA HEAPS IN SHARED MEMORY

(75) Inventors: Erez Landau, Netania (IL); Daniel David Blaukopf, Raanana (IL); Omer Pomerantz, Herzlia (IL)

(73) Assignee: SUN MICROSYSTEMS, INC., Santa Clara, CA (US)

(21) Appl. No.: 12/691,882

(22) Filed: Jan. 22, 2010

(51) Int. Cl. G06F 12/08

(52) U.S. Cl. 711/147; 711/E12.016; 711/E12.009

(57) ABSTRACT

A computing system includes a first virtual machine associated with a memory region readable by the first virtual machine, and a first private memory region. A data object is created by the first virtual machine in the sharable memory region, readable and writeable by the first virtual machine and a second virtual machine. A mapping is established between the first virtual machine and a particular area of the shareable memory region. The computing system includes the second virtual machine associated with a second private memory region, and a reference to the particular area of the shareable memory region. The mapping enables both the first virtual machine and second virtual machine to read and write second data in the shareable memory region without creating a copy of the second data in the first and second private memory regions.

### CROSS-REFERENCE TO RELATED APPLICATIONS

This application is related to U.S. application Ser. No. 11/824,850 entitled “Shared JAVA JAR files,” filed Jul. 2, 2007, having common assignment, and fully incorporated by reference herein.

### BACKGROUND

Multiple Java® virtual machines (JVMs) may concurrently execute on the same computing device (Java is a registered trademark owned by Sun Microsystems, Inc., Mountain View, Calif.). Each such JVM may execute within a separate process (referred to herein as a “JVM process”) that is isolated from the other JVM processes that concurrently execute on the same computing device. Each of these JVM processes may consume a substantial amount of the computing device's memory. The quantity of memory that each JVM process consumes may limit the number of JVM processes that can be executed concurrently on the computing device.

A JVM process needs to load certain programming classes when the JVM process initiates. Loading these classes may require a substantial amount of time. When multiple JVM processes are executed concurrently, the amount of time required for each JVM process to load associated classes may become prohibitive.

Typically, when a JVM process is initiated, the JVM process needs to load a class that is associated with a reference. The reference may be a symbolic name such as, for example, “java.lang.String.” To locate the reference, the JVM process engages in a look-up process which involves a class loader. The class loader defines the class and is configured to load, from a file system, bytes to which the class corresponds. The JVM process processes the loaded bytes and loads the bytes into the JVM processes' internal data structures (e.g., look-up tables) for fast access.

The internal data structures associated with each JVM process are typically stored in memory that has been allocated within the heap of the JVM process. The JVM process may allocate this memory using, for example, a “malloc” call which calls a memory allocation function. The heap memory region of the JVM process is writable private memory that is not shared (referred to hereinafter as “private heap”).

### SUMMARY

In general, in one aspect, the invention relates to a computing system, comprising a first virtual machine, executing on a processor, and associated with a memory region readable by the first virtual machine, and a first private memory region, a shareable memory region defined by first data that is readable and writable by the first virtual machine and a second virtual machine, wherein a mapping is established between the first virtual machine and a particular area of the shareable memory region, and the second virtual machine, executing on the processor, and associated with a second private memory region, and a reference to the particular area of the shareable memory region, wherein the mapping enables both the first virtual machine and second virtual machine to read and write second data in the shareable memory region without creating a copy of any portion of the second data in the first and second private memory regions.

In general, in one aspect, the invention relates to a computer-readable storage medium configure to store instructions, that when executed by one or more processors, performs a method for sharing a programmatic module among isolated virtual machines, comprising creating first data in a defined shareable memory region that is readable and writable by the first virtual machine, establishing a mapping between the first virtual machine and a second virtual machine over a particular area of the shareable memory region, and passing, to the second virtual machine, a reference to a particular area of the shareable memory region, wherein the mapping enables the second virtual machine to read and write second data in the shareable memory region without creating a copy of any portion of the second data in a private memory region of one selected from a group consisting of the first virtual machine and the second virtual machine.

Other aspects of the invention will be apparent from the following description and the appended claims.

### BRIEF DESCRIPTION OF DRAWINGS

FIG. 1 shows a block diagram in accordance with one or more embodiments of the invention.

FIG. 2 shows a flow chart for sharing the SharedClassLoader among isolated JVMs in accordance with one or more embodiments of the invention.

FIGS. 3A-3B show flow charts for garbage collection in accordance with one or more embodiments of the invention.

FIG. 4 shows computing device in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for sharing objects (e.g., data) among isolated virtual machines. More specifically, each virtual machine may load objects using a class loader that has its own memory heap in shared memory, which may facilitate cross-process data sharing between JVMs.

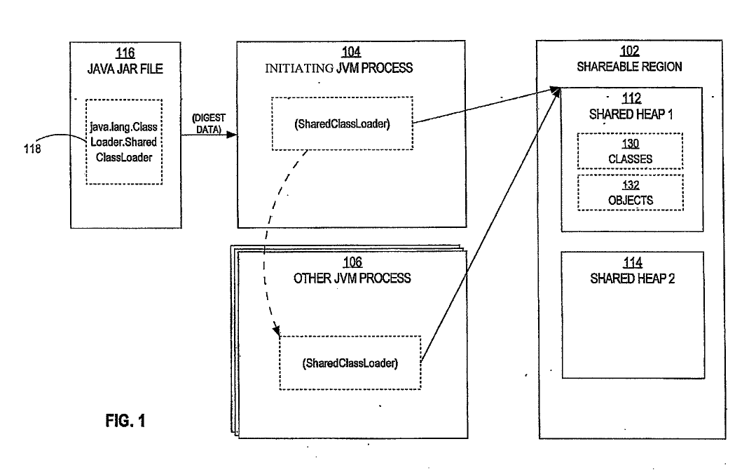

FIG. 1 shows a block diagram that illustrates logical components and aspects of a system for sharing Java® shared heap files among multiple concurrently executing, isolated JVM processes, according to one or more embodiments of the invention. Specifically, FIG. 1 shows a shareable region (102), an Initiating JVM process (104), other JVM processes (106), and a Java® archive (JAR) file (116). Each of the aforementioned components and their interaction is described below.

In one or more embodiments of the invention, a computing device's memory is separated into distinct regions. One such region is shareable region (102). As explained further below, the shareable region (102) is fully readable and writable by one or more JVM processes. While not illustrated in FIG. 1, other “sharable regions” having different characteristics, may co-exist with sharable region (102). For example, a separate sharable region that JVM processes may read from, but not write to, is described in previously-referred application Ser. No. 11/824,850. Additionally, the following patents are also incorporated by reference in their entirety herein: (1) U.S. Pat. No. 5,815,718, issued Sep. 29, 1998 and filed May 30, 1996; (2) U.S. Pat. No. 5,966,542, issued Oct. 12, 1999 and filed Aug. 10, 1998; and (3) U.S. Pat. No. 6,223,346, issued Apr. 24, 2001 and filed Oct. 12, 1999.

Shareable region (102) is created by an Initiating JVM (104) as part of this process' (104) initialization. Once the Initiating JVM process (104) is initialized, other JVM processes (106) that initialize subsequent to the Initiating JVM process (104) are permitted access to the shareable region (102). Additionally, each JVM process (e.g., 104 and 106) has a separate, private ‘read/write’ region (not shown in FIG. 1) into which only that corresponding JVM process may write and read. For example, each JVM process' private read/write region may be implemented as a separate static array that is pre-allocated at build time as part of the program space. Alternatively, the private read/write region may be allocated using UNIX™ (UNIX is a registered trademark of The Open Group) “mmap” or a similar operating system request for allocating private read-write regions. Each JVM has its own stack and heap (called a “private heap” to differentiate it from the shared heap) that also serve as private ‘read/write’ regions.

In one embodiment of the invention, the shareable region (102) further includes one or more shared heaps (112, 114). FIG. 1 illustrates an example in which the shareable region (102) includes a first shared heap (112) and a second shared heap (114), although any number of separate shared heaps is possible within the shareable region (102).

During initialization, while the Initiating JVM process (104) is loading classes (typically, before any of those classes has been requested by any application), Initiating JVM process (104) digests data from a Java® JAR file (116). In one or more embodiments of the invention, the Java® JAR file (116) is a programmatic module that is shared among isolated virtual machines. Java® JAR file (116) is loaded with a “SharedClassLoader” (118) which is a variant of the standard Java® virtual machine specification “ClassLoader”.

While SharedClassLoader (118) behaves in a similar manner to the typical ClassLoader in that the SharedClassLoader has a source of classes which may be loaded on request, in contrast to the standard ClassLoader, SharedClassLoader (118) stores all its data (e.g., classes, objects, and monitors) in a separate heap located in shared memory. That is, instances of classes loaded by the SharedClassLoader are created in the shared memory heap rather than the regular Java® heap. During its initialization, the Initiating JVM process (104) places the digested data into shareable region (102) and acquires a reference (or pointer) to a first shared heap (112). Any JVM process (104) is then free to access and modify objects (132) instantiated from classes (130) residing on the first shared heap (112).

In one or more embodiments, the SharedClassLoader is serializable and may be transferred to an application running on a JVM. The serialized version of the SharedClassLoader may not include the actual data of the SharedClassLoader, but may include only sufficient information to reconstruct the SharedClassLoader in another process such that the new SharedClassLoader instance, attaches itself to the shared memory and uses the shared memory for all operations. The serialized form of the SharedClassLoader may be made up of a single reference and an identifier. Because the SharedClassLoader resides in shared memory, only a native reference to the shared memory may be required to be passed to the new SharedClassLoader. In one embodiment of the invention, another Java® process which receives a SharedClassLoader is immediately able to access classes loaded into the shared memory heap, along with any compiled code, class fields, or object instances stored in the shared memory.

More specifically, in one or more embodiments of the invention, during initialization of the first shared heap (112), the Initiating JVM process (104) acquires sharing information including data regarding shared region (102) in which the first shared heap (112) resides and an actual reference to the first shared heap (112) in the form of a pointer. The Initiating JVM process (104) may then pass this sharing information to one or more other JVM processes (106). Alternatively, a user may pass the sharing information upon invocation of the one or more JVM processes (106). In essence, this provides a serialized version of the SharedClassLoader. Thus, the one or more other JVM processes (106) need not re-create a huge serialized instance but may instead access the first shared heap (112) using the sharing information in a remote method invocation (RMI) or inter-Xlet communication (IXC). Those skilled in the art will appreciate that the serialization of the SharedClassLoader described above allows the ability to pass complex and large objects between isolated JVMs by passing the special serialized form of the SharedClassLoader, which is extremely efficient.

As classes are defined within the SharedClassLoader, any objects later instantiated may be done so on the shared heap. A class may be loaded into more than one ClassLoader. For example, in one or more embodiments, a large part of Java® core library classes are loaded into both the system ClassLoader and into a SharedClassLoader. In the case of a class that is defined in multiple boot ClassLoaders (for example, both the system ClassLoader and a SharedClassLoader that is in the boot classpath), for purposes of the instanceof operator, these are considered the same class if they have the same name. Classes are not considered identical by the VM if they are loaded in non-boot ClassLoaders. When the new operator is used to instantiate a new object in a Java heap, the location of the object class determines which heap used for the new object. An instance of a class that is defined only in the SharedClassLoader will be itself created in the shared heap. For a class that is defined in both the SharedClassLoader and a private ClassLoader, the VM determines whether or not the newly created object is to be immediately assigned to a field of an object in the shared heap. In the case that the new object is to be so assigned, the object is created in the shared heap. Otherwise the object is created in the private heap. A simple algorithm that the VM could use to determine whether an assignation takes place to a field of an object in the shared heap would be to look ahead in the current method's bytecode to determine whether or not the next operation immediately following the object creation is an assignation to such a field. Those skilled in the art will appreciate that other algorithms to determine assignation to the shared heap are possible. If required, the requested class needed for an object in the shared heap is loaded into the relevant SharedClassLoader.

In a scenario in which only one SharedClassLoader is used, a newShared( ) static method may be created that performs exactly as the operator new which allocates the object from the shared heap. The newShared( ) static method may also search for the loaded class in the SharedClassLoader and if the class is not available, then the class is loaded into the SharedClassLoader. The newShared( ) method is useful when initially creating a shared object and assigning its reference into a location in the shared memory heap (or any other location not on the shared heap). As noted above, once an object is allocated to a shared heap, any objects that it creates and assigns to its instance fields are automatically allocated from the shared heap as well.

To the user, creation of a shared heap closely resembles currently known methods to load classes at run time. For example, suppose Java® JAR file “animals” has been configured to load the class “Cat” in a sharable region. Additionally, suppose it is desired that Initiating JVM process “master” should create the shareable region defined from Java® JAR file “animals.” The file “animals.jar” includes a SharedClassLoader constructed using the methods discussed herein. Finally, suppose it is desired that second JVM process “other” have complete access to class “Cat.”

For this example, the user might proceed as follows:
“% java animals.jar master arg1 arg2,” which is a command to run “master” with two args and load “animals;”
“% java SCL animals.jar other,” which is a command to run “other” while indicating “animals” is shareable.

In this example, the command creating second JVM process “other” would include a flag or other designator (here called “SCL”) that would alert the second JVM process to the existence of the shareable region created by the process “master” and would further permit the second JVM process to access and modify all instances of the class “Cat” without re-loading the JAR file “animals.”

In one or more embodiments of the invention, the Initiating JVM process (104) and other JVM processes (106) reside on different computing hardware and have some form of (virtually) shared memory between the computing hardware, with the hardware communicatively coupled together via at least one network connection. Accordingly, the invention allows for the group of virtual machines that access shared objects to be running on different devices, with programmatic ability to access a common shared memory.

Now that implementation of the SharedClassLoader has been described, additional mechanisms, which in one or more embodiments of the invention are involved in the SharedClassLoader's usage, are described below.

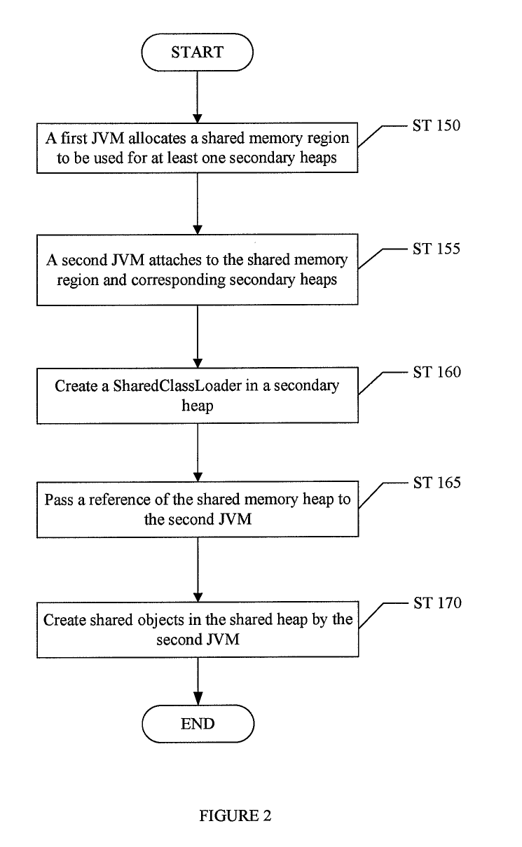

FIG. 2 shows a flow chart for sharing the SharedClassLoader among isolated JVMs in accordance with one or more embodiments of the invention. Initially, the first JVM to run allocates a shared memory region to be used for one or more secondary heaps (ST 150). Each additional JVM to run attaches to this same shared memory region and corresponding secondary heaps (ST 155). Subsequently, a JVM creates a SharedClassLoader in a secondary heap (ST 160). In one or more embodiments of the invention, the SharedClassLoader is copied from a Java® JAR file into the private memory heap of an Initiating JVM process or a subsequent JVM process. More specifically, in one or more embodiments of the invention, one or more Java® classes defined by the SharedClassLoader are copied from the Java® JAR file, which is located in a memory region readable only by the Initiating JVM process that creates the SharedClassLoader, to the private memory heap of the Initiating JVM process. In one or more embodiments of the invention, the copied Java® class data defines the shareable region of memory that is both readable and writable by multiple isolated and distinct JVM processes. Those skilled in the art will appreciate that once the initial loading of the SharedClassLoader is complete, there is no distinction among the various executing JVM processes. Further, in one or more embodiments, each JVM process may serve as a new Initializer for any subsequent (new) SharedClassLoader.

By copying the SharedClassLoader into the Initiating JVM process shared memory, a mapping is established between the Initiating JVM process and the shareable memory region (Step 155). Subsequently, a reference pointing to the shareable region of memory is passed to a JVM process (e.g., a second JVM process distinct from the Initiating JVM process) (Step 165). More specifically, the reference passed may point directly to a shared heap within the shareable memory region created by the SharedClassLoader. In one or more embodiments of the invention, a reference may be passed either through another shared object or through serialization (e.g., Inter-Xlet communication (IXC)). Any other JVM process that receives a reference to the SharedClassLoader may then use the SharedClassLoader and create shared objects in the shared heap (ST 170). In one or more embodiments of the invention, the JAVA® class object data defines the shareable region of memory that is both readable and writable by multiple isolated and distinct JVM processes.

Finally, the mapping established as part of Step 160 enables both the Initiating JVM process and the second JVM process to read and write data in the shared memory heap. Data read/written may include classes and/or objects associated with classes. Thus, multiple isolated and distinct JVM processes are able to read and write data in the shared memory heap without creating a copy of any portion of the data read/written in any private memory region of the multiple isolated JVM processes (Step 165). For example, objects that reference an object in the shared memory heap may be created in a private heap of any of the multiple isolated JVM processes. Regular objects that reference an object in a private heap of a JVM process may not be created in the shared memory heap. The only exception to this rule is the special ProcessLocalReferences object.

### Object References Between a Private Heap and the Shared Memory Heap

Addition of the SharedClassLoader should in no way constrict the ability of a JVM to operate its own private heap. As such, objects in a private heap may include references to objects in the shared memory heap. In addition, there is no limitation on references between two objects that are both on the shared memory heap. In one embodiment of the invention, objects in the shared memory heap may not reference objects in a private heap. Any attempt to do so triggers a runtime exception, unless the assignment is the direct result of a new operator. In that case, the JVM is responsible for allocating the new object from a shared heap, thereby preventing a situation that will cause an exception.

In the situation where it is necessary for an object in the shared memory heap to reference an object in a private heap, the reference is made explicitly using an indirect process-private object reference that is valid only for the assigning process. Such a mechanism, designated “ProcessLocalReferences,” may be similar to the existing ThreadLocal API that assigns values on a per-thread basis.

In this manner, the ProcessLocalReferences may maintain a data structure in shared memory that provides a mapping of JVM identifiers (such as process handles) to reference values (such as addresses in the particular JVM's private heap). When a value is assigned to a ProcessLocalReferences, the value is entered into the mapping as corresponding to the assigning JVM. Programming code in another JVM has no access to this value and will see “null” as the reference value, unless the other JVM has assigned its own value into the mapping.

### Garbage Collection

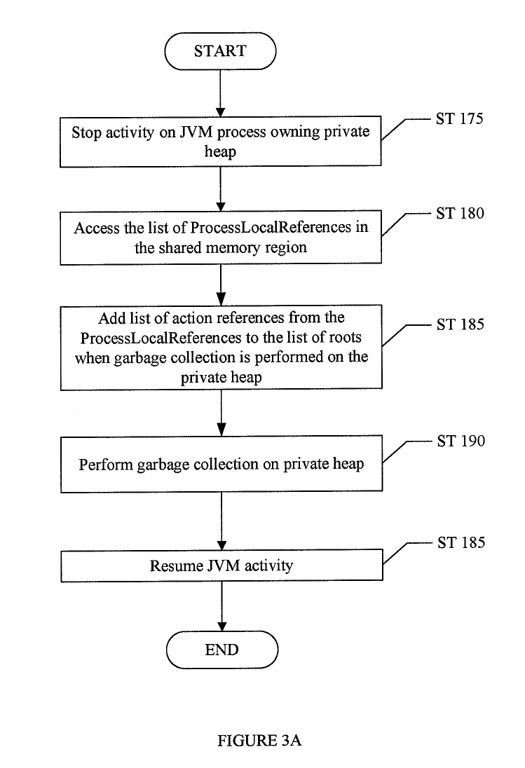

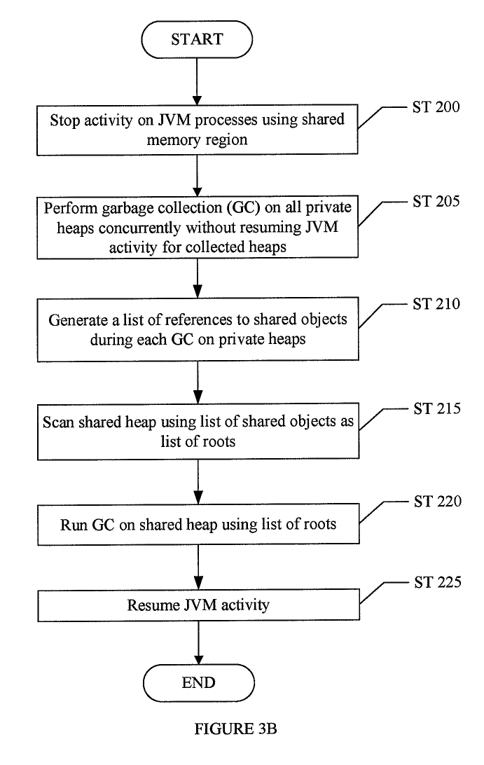

In one or more embodiments of the invention, garbage collection on a shared heap differs from that on a private heap. FIG. 3A shows a flow chart for garbage collection on private heaps in accordance with one or more embodiments of the invention. Initially, upon selection of one of the plurality of JVMs on which to perform garbage collection, all activity on the JVMs having private heaps is stopped (Step 175). In one embodiment of the invention, the scan may be optimized by maintaining a list of ProcessLocalReferences on the shared heap. Next, this list of ProcessLocalReferences in the shared memory region is accessed (ST 180). During this procedure, other JVMs are permitted to access the shared heap, as long as the current JVM (that is, the JVM performing the garbage collection) is blocked from accessing the shared heap.

Once the scan is completed, the list of actual references from the ProcessLocalReferences to the JVM performing the garbage collection is constructed and added to the list of roots when garbage collection is performed on the private heap (Step 185). Garbage collection is then performed on private heaps using the list of roots (ST 190). All activity on the JVMs is subsequently resumed (ST 195). Thus, in contrast to placing multiple applications within a single JVM, an application running inside a JVM performs garbage collection without interfering with other applications running inside other JVMs and related through their use of the shared memory.

FIG. 3B shows a process for performing garbage collection on the shared heap in accordance with one or more embodiments of the invention. Initially, all activity on JVMs using shared memory region is stopped (ST 200). Subsequently, garbage collection is performed on all the private heaps of the JVMs concurrently, without resuming activity on the collected JVMs (Step 205). Garbage collection on the private heaps is performed using the list of ProcessLocalReferences described above. During each garbage collection on the private heaps, a list of references to shared objects is generated (ST 210). The list of shared objects is used as the list of roots for scanning the shared heap (ST 215). Garbage collection on the shared heap is performed using the list of roots generated in ST 210 (Step 220). In one or more embodiments of the invention, this eliminates stale references to the shared heap from the private heaps. Lastly, activity on all the JVMs is resumed (ST 225).

The standard conditions triggering a garbage collection on (a) the SharedClassLoader, (b) all data in the shared heap, and (c) the block of shared memory are when (1) there is no reference from the private heap or stack to data on the shared heap, and (2) there is no reference from the private heap or stack to the SharedClassLoader. These conditions mirror those triggering a garbage collection of a ClassLoader. Other implementations are possible, such as those that those that involve delaying garbage collection of objects on the shared heap until the conditions listed above are met. In one embodiment of the invention, garbage collection on the shared memory waits until one or all applications running in the set of JVMs finally terminate.

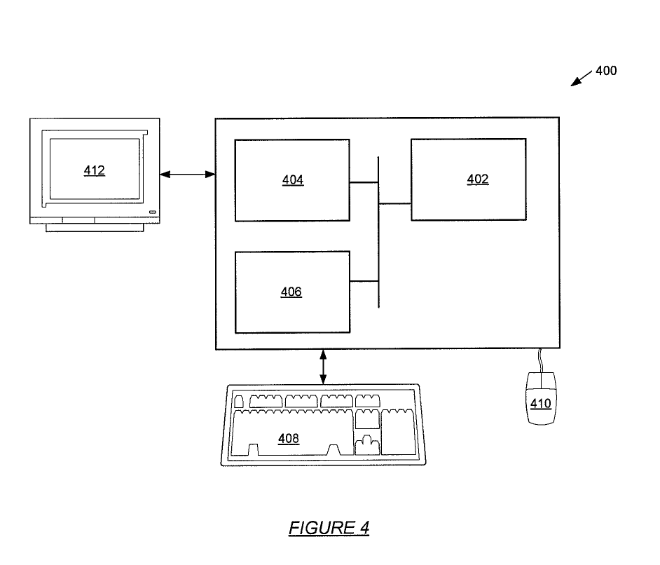

Embodiments of the invention may be implemented on virtually any type of computer device regardless of the platform being used. For example, as shown in FIG. 4, a computer system (400) includes a processor (402), associated memory (404), a storage device (406), and numerous other elements and functionalities typical of today's computers (not shown). The computer (400) may also include input means, such as a keyboard (408) and a mouse (410), and output means (i.e., display device), such as a monitor (412). The computer system (400) may be connected to a network (not shown) (e.g., a local area network (LAN), a wide area network (WAN) such as the Internet, or any other similar type of network) via a network interface connection (not shown). Those skilled in the art will appreciate that these input and output means may take other forms.

Further, those skilled in the art will appreciate that one or more elements of the aforementioned computer system (400) may be located at a remote location and connected to the other elements over a network (not shown). Further, embodiments of the invention may be implemented on a distributed system having a plurality of nodes, where each portion of the implementation may be located on a different node within the distributed system. In one or more embodiments, the node corresponds to a computer system. Alternatively, the node may correspond to a processor with associated physical memory. The node may alternatively correspond to a processor with shared memory and/or resources. Further, software instructions to perform embodiments of hierarchical item level entitlement may be stored on a tangible computer readable medium such as a compact disc (CD), a diskette, a tape, or any other tangible computer readable storage device.

Embodiments of the invention provide a system and method for multiple applications, each running in their own virtual machine, to share the same middleware. Dynamic system-wide data (such as a system-wide resource table) may be shared between applications in a more efficient manner. The invention allows seamless transition of applications using shared middleware from a single Java VM environment to a multiple VM environment, and also allows for memory sharing in Java without native code that must be accessed through JNI.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computing system, comprising:
a first virtual machine, executing on a processor, and associated with:
a memory region readable by the first virtual machine; and
a first private memory region,
a shareable memory region defined by first data that is readable and writable by the first virtual machine and a second virtual machine,
wherein a mapping is established between the first virtual machine and a particular area of the shareable memory region; and
the second virtual machine, executing on the processor, and associated with:
a second private memory region, and
a reference to the particular area of the shareable memory region,
wherein the mapping enables both the first virtual machine and second virtual machine to read and write second data in the shareable memory region without creating a copy of any portion of the second data in the first and second private memory regions.

2. The computing system of claim 1, wherein the first data is a SharedClassLoader that is obtained from a Java® JAR file that is shared among a plurality of virtual machines, wherein the first data corresponds to at least one Java® class in the SharedClassLoader.

3. The computing system of claim 2, wherein the SharedClassLoader is serialized, wherein the serialized SharedClassLoader comprises a single reference and an identifier and is used to pass complex objects between the plurality of virtual machines.

4. The computing system of claim 1, wherein the second virtual machine instantiates the second data from the first data.

5. The computing system of claim 1, wherein the shareable memory region comprises at least one shareable heap.

6. The computing system of claim 5, wherein performing garbage collection on the at least one shared heap comprises:
performing garbage collection on the private heap of the first virtual machine and the private heap of the second virtual machine first; and
performing garbage collection on the at least one shareable heap, while locking all the private heaps.

7. The computing system of claim 6, wherein performing garbage collection on the private heap of one of the first virtual machine and the second virtual machine, comprises:
accessing a list of ProcessLocalReferences in the shared memory region;
adding a list of actual references from the ProcessLocalReferences to a list of roots when garbage collection is performed on the private heaps; and
performing garbage collection on the private heaps using the list of roots.

8. The computing system of claim 5, further comprising:
performing garbage collection on the private heap of the first virtual machine;
performing garbage collection on the private heap of the second virtual machine; and
performing garbage collection on the at least one shareable heap.

9. The computing system of claim 8, further comprising:
performing garbage collection on the shareable memory region.

10. A computer-readable storage medium configured to store instructions, that when executed by one or more processors, performs a method for sharing a programmatic module among isolated virtual machines, comprising:
creating first data in a defined shareable memory region that is readable and writable by the first virtual machine;
establishing a mapping between the first virtual machine and a second virtual machine over a particular area of the shareable memory region; and
passing, to the second virtual machine, a reference to a particular area of the shareable memory region,
wherein the mapping enables the second virtual machine to read and write second data in the shareable memory region without creating a copy of any portion of the second data in a private memory region of one selected from a group consisting of the first virtual machine and the second virtual machine.

11. The computer-readable storage medium of claim 10, wherein the programmatic module is a Java® JAR file, and wherein the first data corresponds to at least one Java® class.

12. The computer-readable storage medium of claim 10, wherein the second virtual machine instantiates the second data from the first data.

13. The computer-readable storage medium of claim 10, wherein the shareable memory region comprises at least one shareable heap.

14. The computer-readable storage medium of claim 13, further comprising instructions for creating, in a private heap of one selected from a group consisting of the first virtual machine and the second virtual machine, at least one object that references an object in the at least one shareable heap.

15. The computer-readable storage medium of claim 14, further comprising instructions for creating, in the at least one shareable heap, at least one special object of type ProcessLocalReference that references an object in a private heap of one selected from a group consisting of the first virtual machine and the second virtual machine.

16. The computer-readable storage medium of claim 15, wherein the instructions for creating the at least one object in the at least one shareable heap further include using an indirect process-private object reference that is valid only for the assigning process.

17. The computer-readable storage medium of claim 16, further comprising instructions for performing garbage collection on the private heap of one selected from a group consisting of the first virtual machine and the second virtual machine and the at least one shareable heap.

18. The computer-readable storage medium of claim 16, wherein the shared memory includes a data structure ProcessLocalReferences providing a mapping of virtual machine identifiers to the indirect process-private object reference.

19. The computer-readable storage medium of claim 18, further comprising instructions for performing garbage collection on the private heap of either the first virtual machine or the second virtual machine, the garbage collection comprising:
accessing the data structure ProcessLocalReferences in the shared memory region;
adding a list of actual references from the ProcessLocalReferences to a list of roots when garbage collection is performed on the private heaps; and
performing garbage collection on the private heaps using the list of roots.

20. The computer-readable storage medium of claim 17, further comprising instructions for:
performing garbage collection on the private heap of the first virtual machine;
performing garbage collection on the private heap of the second virtual machine; and
performing garbage collection on the at least one shareable heap.
